(19) United States
(12) Patent Application Publication
(10) Pub. No.: US 2008/0001573 A1
(43) Pub. Date: Jan. 3, 2008

(54) Portable electronic device

(76) Inventor: David W. Carey, Rancho Santa Fe, CA (US)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/480,333

(22) Filed: Jun. 29, 2006

(51) Int. Cl. H02J 7/00

(52) U.S. Cl. 320/112

(57) ABSTRACT

A portable electronic device includes a main housing and a battery pack that is detachable from the main housing. The battery pack includes a battery pack housing configured to attach to the main housing, a battery in the battery pack housing, and a power connection in the battery pack housing for connecting the battery to the portable electronic device. The battery pack further includes one or more integrated circuits in the battery pack housing, the functional electronics including a chipset, and a data connection in the battery pack housing for connecting the one or more integrated circuits to the portable electronic device.

### BACKGROUND

Portable electronic devices include cellular phones, personal digital assistants (PDAs), messaging devices, pagers or other electronic, battery-powered communication devices. Portable electronic devices include a number of basic hardware parts: a circuit board or printed wiring board hosting integrated circuits such as chipsets and memory, a keypad or other input device, a display, and a main housing that encases or hosts these basic hardware parts. Portable electronic devices also generally include a rechargeable battery. The battery is often encased in its own housing that fits the form of the main housing, so that it is easily removable and replaceable.

In recent years, portable electronic devices have seen explosive growth in capabilities and technology, leading to ever-increasing requirements for enhanced computing power, memory, and other functions. Most of the new capabilities are provided by new and improved chipsets and other hardware. However, except for the battery, the hardware of portable electronic devices is generally not easily upgradeable or replaceable. For instance, mobile cellular phones are marketed and sold with particular chipsets for certain radio functionality. Upgrades to the chipsets are not feasible because of their location and arrangement within the main housing. Thus, users wanting to upgrade to better hardware are forced to purchase a new portable electronic device.

There are some situations in which functionality of a portable electronic device is not desired. For example, many locations prohibit the use of cameras, which are increasingly found on cellular telephones and other portable electronic devices. Cameras or other functional devices are usually sold with the portable electronic device as a singular unit, and currently there is no way to detach such functionality, or to remove and upgrade such functionality.

Thus, what is needed is a modular portable electronic device.

### SUMMARY

This document discloses devices and techniques for maintaining or upgrading hardware components of a portable electronic device that provide advanced functionality such as logic, processing, or memory.

In one aspect, a battery pack for a portable electronic device includes a battery pack housing configured to attach to the portable electronic device, and a battery in the battery pack housing. The battery pack further includes a power connection in the battery pack housing for connecting the battery to the portable electronic device. The battery pack further includes one or more integrated circuits in the battery pack housing, and a data connection in the battery pack housing for connecting the one or more integrated circuits to the portable electronic device.

In another aspect, a portable electronic device includes a main housing and a battery pack detachable from the main housing. The battery pack includes a battery pack housing that is configured to attach to the main housing. In this aspect, the battery pack further includes a battery in the battery pack housing, a power connection in the battery pack housing for connecting the battery to the portable electronic device, one or more integrated circuits in the battery pack housing, the functional electronics including a chipset, and a data connection in the battery pack housing for connecting the one or more integrated circuits to the portable electronic device.

In yet another aspect, a method of upgrading a portable electronic device includes the step of forming a detachable battery pack having a battery, a power output connection connected to the battery, one or more integrated circuits, and a data connection connected to the one or more integrated circuits. The method further includes the step of attaching the detachable battery pack to a main housing of the portable electronic device, the main housing including a power input connection for connecting with the power output connection, and a second data connection for connecting with the detachable battery pack data connection.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a portable electronic device in the form of a cellular phone.

FIG. 2 is a block diagram of a detachable battery pack.

FIG. 3 is a block diagram of functional modules for a portable electronic device and battery pack.

Like reference symbols in the various drawings indicate like elements.

### DETAILED DESCRIPTION

This document describes a detachable mechanism for a portable electronic device. The detachable mechanism includes one or more integrated circuits. In one embodiment, the detachable mechanism forms a detachable battery pack that is sized and formed to fit into a cavity or recess of a main housing of the portable electronic device. The battery pack includes a battery, a power output connection connected to the battery, a data connection, and one or more integrated circuits connected to the data connection. The detachable mechanism can be used for upgrading functionality provided by the one or more integrated circuits for the portable electronic device.

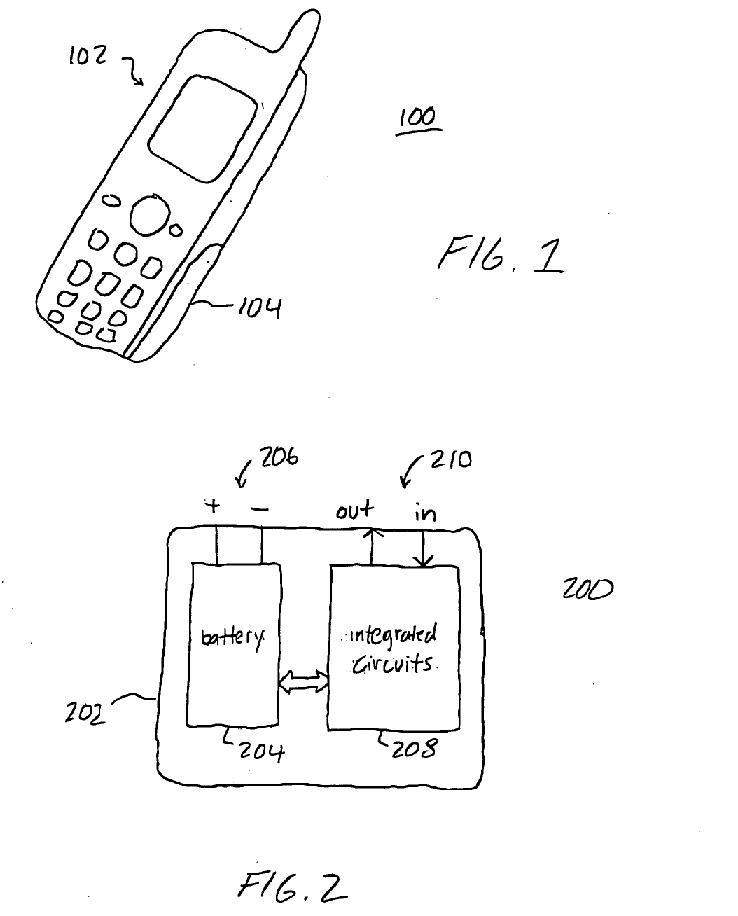

FIG. 1 illustrates an exemplary embodiment of a portable electronic device 100 that is suitable for employing the mechanisms and techniques described herein. The portable electronic device 100 includes a main housing 102 and a detachable battery pack 104. The portable electronic device 100 is embodied in the example as a mobile cellular phone. The main housing 102 contains a keypad, a display, an antenna, and some electronics for basic functionality.

In accordance with embodiments, the detachable battery pack 104 includes a housing that contains a battery and at least one integrated circuit, microchip, and/or chipset that implements advanced functionality. A microchip, also simply called a “chip” is a unit of packaged computer circuitry called an integrated circuit, that is manufactured from a material such as silicon, and at a very small scale. Microchips are made for program logic (logic or microprocessor chips) and for computer memory (memory or RAM chips). Microchips are also made that include both logic and memory, and for special purposes such as analog-to-digital conversion, bit slicing, gateways, and digital signal processing. A chipset is a group of integrated circuits or microchips that operate together to serve a single function or set of functions, and are typically manufactured and sold as a single unit.

The main housing 102 of the portable electronic device 100 can be made of plastic or metal. The detachable battery pack 104 housing can also be made of plastic or metal, and is preferably formed of a shape and material to fit complementary with the main housing 102. For example, the main housing 102 can include a cavity or recess of a particular form factor, which can be occupied by the detachable battery pack 104 when it is attached to the main housing 102.

FIG. 2 is a block diagram of a detachable battery pack 200 for a portable electronic device in accordance with preferred embodiments. The detachable battery pack 200 includes a housing 202 that contains a battery 204, and a power connection 206 connected to the battery and configured to connect with a complementary power connection provided by the portable electronic device. The detachable battery pack 200 further includes one or more integrated circuits 208, and a data connection 210 connected to the one or more integrated circuits 208 and configured to connect with a complementary data connection in the portable electronic device.

The data connection 210 is preferably a two-way, high-speed data connection to transfer digital multimedia data to and from the one or more integrated circuits 208. The data connection 210 can be a Personal Computer Memory Card International Association-compatible (PCMCIA) connection, Universal Serial Bus (USB), high speed data connections, and radio frequency channel connections as well.

The one or more integrated circuits 208 includes logic and/or memory circuitry, and forms a number of transistors, capacitors, and/or resistors. The integrated circuits 208 can be formed into a chipset for digital multimedia processing, radio signal processing, or the like. In some embodiments, the one or more integrated circuits 208 include a memory, such as RAM, DRAM, or flash memory. The one or more integrated circuits 208 can include image capture and processing circuits attached to a camera (not shown). Accordingly, functionality such as a camera or additional communication capabilities such as the Global Positioning System (GPS), WI-FI, etc., can be attachable to and detachable from the portable electronic device as desired.

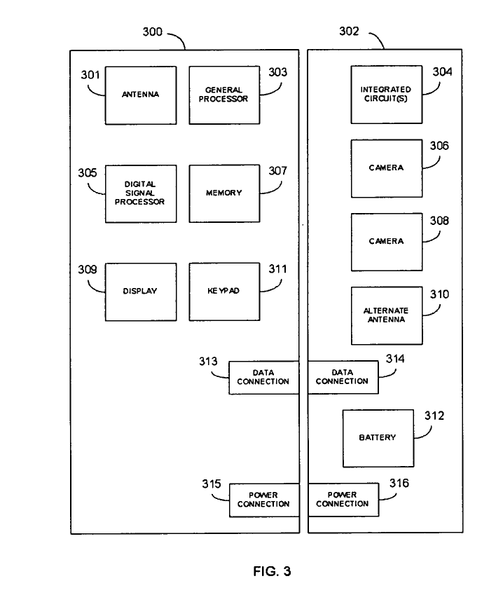

FIG. 3 is a block diagram representing a portable electronic device 300 and a detachable battery pack 302. The portable electronic device 300 is encased in a housing such as plastic, and can include an antenna 301, a general processor 303 for running software applications and operating systems, a digital signal processor 305 for processing voice and data signals received from the antenna 301, and a memory 307 for storing the applications and operating systems computer code, as well as data for processes of the applications and operating systems, results thereof, and user input data. The portable electronic device 300 further includes a display 309 such as a color graphics display, for displaying a graphical user interface or other interface, and a keypad 311 such as an alphanumeric keypad or keyboard composed of a number of mechanical or electrical user-operable keys by which character and other data is entered into the memory 307.

The detachable battery pack 302 includes one or more integrated circuits 304 that comprise functionality that is an addition to, or enhancement or upgrade of, functionality provided by the portable electronic device. For example, the integrated circuits 304 can include most-recent releases of signal processing software and firmware, or may include upgraded processors for processing voice and data signals received on the antenna 301 of the portable electronic device 300. The integrated circuits 304 may also be specific processor and memory circuits for such functions as a camera 306 contained in the detachable battery pack 302.

In use, the detachable battery pack 302 can provide camera functionality and image processing capabilities that are removable from the portable electronic device 300. Other functions are possible, such as media players, video cameras, GPS mapping interfaces, alternate user displays for other user interfaces, measurement instruments, or output devices such as audio speakers, video displays, etc. The detachable battery pack 302 may also have an alternate antenna 310 for GPS signal reception, or to augment the capabilities of the antenna 301 of the portable electronic device 300.

The detachable battery pack 302 further includes a data connection 314 for connecting to and transmitting data and electrical signals between a complementary data connection 313 in the portable electronic device 300. The detachable battery pack 302 also includes a battery 312, and a power connection 316 for connecting to and transmitting electrical power to a complementary power connection 315, and for powering the modules of the portable electronic device 300 and/or the detachable battery pack 302. The battery 312 can be a single battery or a set of batteries. The set of batteries can be connected to separately power the portable electronic device 300 and the detachable battery pack 302.

Although a few embodiments have been described in detail above, other modifications are possible. Other embodiments may be within the scope of the following claims.

1. A battery pack for a portable electronic device, comprising:
a battery pack housing configured to attach to the portable electronic device;
a battery in the battery pack housing;
a power connection in the battery pack housing for connecting the battery to the portable electronic device;
one or more integrated circuits in the battery pack housing; and
a data connection in the battery pack housing for connecting the one or more integrated circuits to the portable electronic device.

2. A battery pack in accordance with claim 1, wherein the one or more integrated circuits comprise at least one chipset.

3. A battery pack in accordance with claim 2, wherein the at least one chipset is configured to process digital signals.

4. A battery pack in accordance with claim 3, wherein the digital signals includes voice.

5. A battery pack in accordance with claim 3, wherein the digital signals includes video.

6. A battery pack in accordance with claim 3, wherein the digital signals comprise multimedia signals.

7. A battery pack in accordance with claim 1, wherein the one or more integrated circuits comprise a memory.

8. A portable electronic device comprising:
a main housing;
a battery pack detachable from the main housing, and comprising:
a battery pack housing configured to attach to the main housing;
a battery in the battery pack housing;
a power connection in the battery pack housing for connecting the battery to the portable electronic device;
one or more integrated circuits in the battery pack housing, the functional electronics including a chipset; and
a data connection in the battery pack housing for connecting the one or more integrated circuits to the portable electronic device.

9. A portable electronic device in accordance with claim 8, wherein the one or more integrated circuits comprise at least one chipset.

10. A portable electronic device in accordance with claim 9, wherein the at least one chipset is configured to process digital signals.

11. A portable electronic device in accordance with claim 10, wherein the digital signals includes voice.

12. A portable electronic device in accordance with claim 10, wherein the digital signals includes video.

13. A portable electronic device in accordance with claim 10, wherein the digital signals comprise multimedia signals.

14. A portable electronic device in accordance with claim 8, wherein the one or more integrated circuits comprise a memory.

15. A portable electronic device in accordance with claim 8, wherein the battery pack includes a camera.

16. A method of upgrading a portable electronic device, comprising:
forming a detachable battery pack having a battery, a power output connection connected to the battery, one or more integrated circuits, and a data connection connected to the one or more integrated circuits; and
attaching the detachable battery pack to a main housing of the portable electronic device, the main housing including a power input connection for connecting with the power output connection, and a second data connection for connecting with the detachable battery pack data connection.

17. A portable electronic device, comprising:
a main housing;
a detachable battery pack configured to connect to the main housing and having a power output connection; and
a detachable functional pack configured to connect to the main housing, the functional pack including at least one integrated circuit and a data connection connected to the at least one integrated circuit.

18. A portable electronic device in accordance with claim 16, wherein the main housing further comprises a first cavity or recess arranged to receive the detachable battery pack.

19. A portable electronic device in accordance with claim 17, wherein the main housing further comprises a second cavity or recess arranged to receive the detachable functional pack.

20. A portable electronic device, comprising:
a main housing having a power input connection and a first data connection;
a detachable battery pack configured to connect to the main housing, the detachable battery pack including a power output connection configured to connect to the power input connection, a second data connection configured to connect to the first data connection, and one or more integrated circuits connected to the data connection.

21. A portable electronic device in accordance with claim 19, wherein the main housing further comprises a cavity or recess for receiving the detachable battery pack.
